(19) United States
(12) Patent Application Publication
(10) Pub. No.: US 2026/0045542 A1
(43) Pub. Date: Feb. 12, 2026

(54) SOLID COMPOSITE ELECTROLYTE

(71) Applicant: SOLVAY SPECIALTY POLYMERS ITALY S.P.A., Bollate (Milano) (IT)

(72) Inventors: Vincent Finsy, Halle (BE); Eliana Ieva, Alessandria (IT); Alessio Marrani, Lecco (LC) (IT); Francesco Liberale, Pavia (IT)

(73) Assignee: SOLVAY SPECIALTY POLYMERS ITALY S.P.A., Bollate (Milano) (IT)

(21) Appl. No.: 19/102,776

(22) PCT Filed: Jul. 26, 2023
(86) PCT No.: PCT/EP2023/070756

§ 371 Date: Feb. 10, 2025

(30) Foreign Application Priority Data
Aug. 10, 2022 (EP) 22189656.6

(51) Int. Cl. H01M 10/056; H01M 10/052

(52) U.S. Cl. CPC H01M 10/056; H01M 10/052; H01M 2300/008; H01M 2300/0082; H01M 2300/0091

(57) ABSTRACT

The present invention relates to a solid composite electrolyte comprising a) at least one fluoroelastomer and b) at least one sulfide-based solid ionic conducting inorganic particles that differs from a lithium salt, wherein a) the fluoroelastomer comprises recurring units derived from i) vinylidene difluorides and ii) from 15.0 to 80.0 mol % of at least one C₂-C₈ chloro and/or bromo and/or iodo fluoroolefin, the mol % being relative to the total moles of recurring units, wherein the solid composite electrolyte does not contain a lithium salt; to a slurry for manufacturing a solid composite electrolyte comprising a) a fluoroelastomer and b) a sulfide-based solid ionic conducting inorganic particle that differs from a lithium salt, and c) at least one non-aqueous solvent, wherein the slurry does not contain a lithium salt; and to a solid-state battery comprising a positive electrode, a negative electrode and a membrane, at least one among which comprises a solid composite electrolyte according to the present invention. The present invention also relates to a binder solution for a solid-state battery comprising a) at least one fluoroelastomer and c) at least one non-aqueous solvent.

### CROSS-REFERENCE TO RELATED APPLICATION

This application claims priority to a European patent application No. 22189656.6 filed on Aug. 10, 2022, the whole content of this application being incorporated herein by reference for all purposes.

### TECHNICAL FIELD

The present invention relates to a solid composite electrolyte comprising a) at least one fluoroelastomer and b) at least one sulfide-based solid ionic conducting inorganic particle that differs from a lithium salt, wherein a) the fluoroelastomer comprises recurring units derived from i) vinylidene difluorides and ii) from 15.0 to 80.0 mol % of at least one C₂-C₈ chloro and/or bromo and/or iodo fluoroolefin, the mol % being relative to the total moles of recurring units, wherein the solid composite electrolyte does not contain a lithium salt; to a slurry for manufacturing a solid composite electrolyte comprising a) a fluoroelastomer, b) a sulfide-based solid ionic conducting inorganic particle that differs from a lithium salt, and c) at least one non-aqueous solvent, wherein the slurry does not contain a lithium salt; to an electrode comprising a solid composite electrolyte according to the present invention, d) at least one electroactive material, and optionally e) at least one conductive agent; and to a solid-state battery comprising a positive electrode, a negative electrode and a membrane, at least one among which comprises a solid composite electrolyte according to the present invention. The present invention also relates to a binder solution for a solid-state battery comprising a) at least one fluoroelastomer according to the present invention and c) at least one non-aqueous solvent.

### TECHNICAL BACKGROUND

Lithium-ion batteries have retained dominant position in the market of rechargeable energy storage devices for decades, thanks to their many benefits such as light-weight, reasonable energy density and good cycle life. Nonetheless, better safety and higher energy density have been continuously required pursuant to the development of high power applications such as electrical vehicles, hybrid electrical vehicles, grid energy storage, etc.

Solid-state batteries are hence believed to be the next generation of energy storage devices, where the highly flammable liquid electrolyte is replaced by a solid-state electrolyte that the risk of ignition and/or explosion can be substantially removed. As solid-state electrolytes, organic polymer, inorganics and composites have been actively investigated, each of which has its own pros and cons. In particular, the composites, i.e. inorganic electrolytes dispersed into polymers, e.g. those comprising sulfide particles dispersed into a polymeric matrix, are considered as being the most promising solution at industrial scale, in view of the high ionic conductivity of the sulfide-based solid electrolyte, and good mechanical properties and easy processability of the polymers. Nonetheless, there also exists drawbacks to be solved, such as poor solvent compatibility of sulfide materials which largely restricts the selection of the polymers that can be used to fabricate electrolytes, insufficient adhesion towards current collectors of electrodes, rather complex process in manufacturing a solid composite electrolyte, relatively weak flexibility of a solid composite electrolyte, etc.

US 2015/096169 A1 (Kureha Corp. and Toyota) discloses that a positive electrode for a sulfide-based solid-state battery, which is formed with a slurry containing a fluorine-based copolymer having a specific amount of VDF units (between 40 and 70 mol %), exerts good adhesion towards a current collector.

WO 2021/039950 (Fujifi/m) describes that an inorganic solid electrolyte-containing composition comprising an inorganic solid electrolyte, a polymeric binder and a dispersion medium, wherein the polymeric binder comprises a fluorine-based copolymer that contains a VDF component and from 21 to 65 mol % of hexafluoropropylene (HFP) component, exhibits more than 60% of adsorption to inorganic solid electrolytes and is effective in controlling excessive increase of viscosity, re-coagulation or sedimentation of inorganic particles that a solid-state battery having superior cycling properties can be achieved. In particular, the polymeric binder exhibits tensile fracture strain of 500% or more.

There still remains however a continuous need in this field for a sulfide-based solid composite electrolyte, which exhibits outstanding adhesion towards a current collector and/or better flexibility, while maintaining high ionic conductivity and good mechanical properties.

### SUMMARY OF THE INVENTION

A first object of the present invention is a solid composite electrolyte comprising a) at least one fluoroelastomer and b) at least one sulfide-based solid ionic conducting inorganic particle that differs from a lithium salt, wherein a) the fluoroelastomer comprises recurring units derived from i) vinylidene difluorides (VDF) and ii) from 15.0 to 80.0 mol % of at least one C₂-C₈ chloro and/or bromo and/or iodo fluoroolefin, the mol % being relative to the total moles of recurring units, wherein the solid composite electrolyte does not contain a lithium salt.

A second object of the present invention is a slurry for manufacturing a solid composite electrolyte comprising a) a fluoroelastomer, b) a sulfide-based solid ionic conducting inorganic particle that differs from a lithium salt, and c) at least one non-aqueous solvent, wherein the slurry does not contain a lithium salt.

A third object of the present invention is an electrode comprising a solid composite electrolyte according to the present invention, d) at least one electroactive material, and optionally e) at least one conductive agent.

A fourth object of the present invention is a solid-state battery comprising a positive electrode, a negative electrode, and a membrane that is positioned between the positive electrode and the negative electrode, wherein at least one of the positive electrode, the negative electrode and the membrane comprises a solid composite electrolyte according to the present invention, optionally d) at least one electroactive material and/or e) at least one conductive agent.

A fifth object of the present invention is a binder solution for a solid-state battery comprising a) at least one fluoroelastomer according to the present invention and c) at least one non-aqueous solvent.

It was surprisingly found by the inventors that the solid composite electrolyte according to the present invention may deliver a particularly advantageous combination of properties, e.g. excellent adhesion towards a current collector, better flexibility, etc.

### BRIEF DESCRIPTION OF DRAWINGS

FIG. 1 is a cross-section of the pressure cell in AC impedance spectroscopy, developed within Solvay to measure the ionic conductivity of the film. In the pressure cell, the film is pressed between 2 stainless steel electrodes during impedance measurement.

FIG. 2 represents an equivalent circuit for modelling conductivity behaviours of solid composite electrolytes, wherein R1 and R2 represent the bulk and grain boundary resistance respectively, and Q2 and Q3 represent the grain boundary and electrode contributions respectively.

### DETAILED DESCRIPTION OF THE INVENTION

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. In the context of the present invention, the term ‘percent by weight’ (wt %) indicates the content of a specific component in a mixture, calculated as the ratio between the weight of the component and the total weight of the mixture. As used herein, the concentration of recurring units in ‘percent by mol’ (mol %) refers to the concentration relative to the total number of recurring units in the polymer, unless explicitly stated otherwise.

It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention provides a solid composite electrolyte comprising:
a) at least one fluoroelastomer; and
b) at least one sulfide-based solid ionic conducting inorganic particle that differs from a lithium salt;
wherein a) the fluoroelastomer comprises recurring units derived from
i) vinylidene difluorides (VDF); and
ii) from 15.0 to 80.0 mol % of at least one C₂-C₈ chloro and/or bromo and/or iodo fluoroolefin, the mol % being relative to the total moles of recurring units,
wherein the solid composite electrolyte does not contain a lithium salt.

In one embodiment, ii) the C₂-C₈ chloro and/or bromo and/or iodo fluoroolefin accounts for from 15.0 to 65.0 mol %, preferably from 15.0 to 50.0 mol %, the mol % being relative to the total moles of recurring units.

In another embodiment, ii) the C₂-C₈ chloro and/or bromo and/or iodo fluoroolefin is selected from the group consisting of 1,1-chlorofluoroethylene (CFE), chlorodifluoroethylene (CDFE), bromotrifluoroethylene, chlorotrifluoroethylene (CTFE), 1,2-dichloro-1,2-difluoroethylene, iodotrifluoroethylene, and combinations thereof.

In a particular embodiment, ii) the C₂-C₈ chloro and/or bromo and/or iodo fluoroolefin is cis-1,2-dichloro-1,2-difluoroethylene or trans-1,2-dichloro-1,2-difluoroethylene, preferably trans-1,2-dichloro-1,2-difluoroethylene.

In another particular embodiment, ii) the C₂-C₈ chloro and/or bromo and/or iodo fluoroolefin is chlorotrifluoroethylene (CTFE).

In a preferred embodiment, a) the fluoroelastomer comprises recurring units derived from VDF and CTFE.

In a more preferred embodiment, a) the fluoroelastomer comprises recurring units derived from 80.0 mol % of VDF and 20.0 mol % of CTFE.

In another more preferred embodiment, a) the fluoroelastomer comprises recurring units derived from 70.0 mol % of VDF and 30.0 mol % of CTFE.

In the other more preferred embodiment, a) the fluoroelastomer comprises recurring units derived from 60.0 mol % of VDF and 40.0 mol % of CTFE.

In one embodiment, a) the fluoroelastomer further comprises recurring units derived from iii) at least one C₂-C₈ fluoroolefin, different from i) and ii).

In the present invention, iii) the C₂-C₈ fluoroolefin is selected from the group consisting of:
C₂-C₈ perfluoroolefins, such as tetrafluoroethylene (TFE), hexafluoropropylene (HFP);
hydrogen-containing C₂-C₈ fluoroolefins, such as vinyl fluoride (VF), trifluoroethylene (TrFE), hexafluoroisobutylene;
(per)fluoroalkyl ethylenes of formula CH₂=CH—R_{f}, wherein R_{f} is a C₁-C₆ (per)fluoroalkyl group;
(per)fluoroalkyl vinylethers (PAVE) of formula CF₂=CFOR_{f}, wherein R_{f} is a C₁-C₆ (per)fluoroalkyl group;
(per)fluorooxyalkyl vinylethers of formula CF₂=CFOX, wherein X is a C₁-C₁₂ ((per)fluoro)oxyalkyl;
(per)fluorodioxoles having formula of

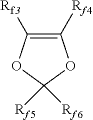

wherein R_{f3}, R_{f4}, R_{f5}, and R_{f6}, equal or different from each other, are independently selected among fluorine atoms and C₁-C₆ (per)fluoroalkyl groups, optionally comprising at least one oxygen atom;
(per)fluoroalkoxy vinylethers (MOVE) of formula CFX₂=CX₂OCF²OR″_{f}, wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂ is F or H; preferably R″_{f} is —CF₂CF₃ (MOVE1), —CF₂CF₂OCF₃ (MOVE2), or —CF₃ (MOVE3) and X₂ is F; and
combinations thereof.

In a particular embodiment, iii) the C₂-C₈ fluoroolefin is selected from the group consisting of vinyl fluoride (VF), trifluoroethylene (TrFE), tetrafluoroethylene (TFE), hexafluoropropylene (HFP), hexafluoroisobutylene, and combinations thereof.

In the present invention, the fluoroelastomer may be manufactured by suspension or emulsion polymerization process.

In the present invention, the term “fluoroelastomer” is intended to designate a fluoropolymer resin serving as a base constituent for obtaining a true elastomer. True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers are in general amorphous, exhibit a low degree of crystallinity, i.e. having crystalline phase less than 20 vol %, and have a glass transition temperature (T_{g}) below room temperature. In most cases, the fluoroelastomer has advantageously a T_{g} below 10° C., preferably below 5° C., more preferably below 0° C., even more preferably below −5° C.

The term “amorphous” is hereby intended to denote a polymer having a heat of fusion of less than 5.0 J/g, preferably of less than 3.0 J/g, and more preferably of less than 2.0 J/g as measured by Differential Scanning Calorimetry (DSC) at a heating rate of 10° C./min according to ASTM D3418.

In the present invention, the term “sulfide-based solid ionic conducting inorganic particle” is not particularly limited as long as it is a solid electrolyte material containing sulfur atom(s) in the molecular structure or in the composition.

The sulfide-based solid ionic conducting inorganic particle preferably contains Li, S, and an element of from 13 to 15 groups, for instance, P, Si, Sn, Ge, Al, As, Sb, or B, to increase Li-ion conductivity.

The sulfide-based solid ionic conducting inorganic particle according to the present invention is preferably selected from the group consisting of:
lithium tin phosphorus sulfide (“LSPS”) materials, such as Li₁₀SnP₂S₁₂;
lithium phosphorus sulfide (“LPS”) materials, such as glass, crystalline or glass-ceramic of those of formula (Li₂S)ₓ—(P₂S₅)_{y}, wherein x+y=1 and 0≤x≤1, Li₇P₃S₁₁, Li₇PS₆, Li₄P₂S₆, Li_{9.6}P₃S₁₂ and Li₃PS₄;
doped LPS, such as Li₂CuPS₄, Li₁₊₂ₓZn₁₋ₓPS₄, wherein 0≤x≤1, Li_{3.33}Mg_{0.33}P₂S₆, and Li₄₋₃ₓScₓP₂S₆, wherein 0≤x≤1;
lithium phosphorus sulfide oxygen (“LPSO”) materials of formula LiₓP_{y}S_{z}O, wherein 0.33≤x≤0.67, 0.07≤y≤0.2, 0.4≤z≤0.55;
lithium phosphorus sulfide materials including X (“LXPS”), wherein X is Si, Ge, Sn, As, or Al, such as Li₁₀SnP₂S₁₂, Li₁₀GeP₂S₁₂, Li₁OSiP₂S₁₂, and Li₂S—P₂S₅—SnS;
lithium phosphorus sulfide oxygen including X (“LXPSO”), wherein X is Si, Ge, Sn, As, or Al;
lithium silicon sulfide (“LSS”) materials, such as Li₂SiS₃, Li₂S—P₂S₅—SiS₂, Li₂S—P₂S₅—SiS₂—LiCl, Li₂S—SiS₂—P₂S₅, Li₂S—SiS₂—P₂S₅—LiI, Li₂S—SiS₂—LiI, Li₂S—SiS₂, Li_{9.54}Si_{1.74}P_{1.44}S_{11.7}Cl_{0.3}, and Li₂S—SiS₂—Al₂S₃;
lithium boron sulfide materials, such as Li₃BS₃ and Li₂S—B₂S₃—LiI;
lithium tin sulfide materials and lithium arsenide materials, such as Li_{0.8}Sn_{0.8}S₂, Li₄SnS₄, Li_{3.833}Sn_{0.833}As_{0.1}MS₄, Li₃AsS₄—Li₄SnS₄, and Ge-substituted Li₃AsS₄;
lithium phosphorus sulfide materials of general formula LiaPSbXc, wherein X represents at least one halogen element selected from the group consisting of Cl, Br and I or a combination thereof; and a represents a number from 2.0 to 7.0, b represents a number from 3.5 to 6.0, and c represents a number from 0 to 3.0, such as Li₄PS₄Cl, Li₇P₂S₈Cl, and Li₇P₂S₈I; and
combinations thereof.

In a more preferred embodiment, the sulfide-based solid ionic conducting inorganic particle is a lithium phosphorus sulfide material of the above general formula LiₐPS_{b}X_{c}, more particularly Argyrodite-type sulfide material of formula Li₆PS₅X, wherein X is Cl, Br or I.

In another preferred embodiment, the Argyrodite-type sulfide material of formula Li₆PS₅Y is deficient in sulfur and/or lithium, for instance Li₆₋ₓPS₅₋ₓCl₁₊ₓ with 0≤x≤0.5, or doped with a heteroatom.

Particularly preferred sulfide-based solid ionic conducting particles are lithium tin phosphorus sulfide (“LSPS”) materials (e.g. Li₁₀SnP₂S₁₂) and Argyrodite-type sulfide materials (e.g. Li₆PS₅Cl).

In one embodiment, an amount of b) the sulfide-based solid ionic conducting inorganic particle is at least 40.0 wt %, preferably at least 60.0 wt %, more preferably at least 70.0 wt %, much more preferably at least 80.0 wt %, and most preferably at least 90.0 wt %, and/or at most 99.8 wt %, preferably at most 99.5 wt %, more preferably at most 99.0 wt %, and most preferably at most 98.0 wt %, based on the total weight of the solid composite electrolyte.

In a particular embodiment, the amount of b) the sulfide-based solid ionic conducting inorganic particle is from 40.0 to 99.8 wt %, preferably from 60.0 to 99.5 wt %, more preferably from 70.0 to 99.0 wt %, even more preferably from 80.0 to 99.0 wt %, and most preferably from 90.0 to 99.0 wt %, based on the total weight of the solid composite electrolyte.

In a more particular embodiment, the amount of b) the sulfide-based solid ionic conducting inorganic particle is from 95.0 to 99.0 wt %, based on the total weight of the solid composite electrolyte.

In the present invention, b) at least one sulfide-based solid ionic conducting inorganic particle differs from a lithium salt, conventionally used as an essential element of a lithium secondary battery.

The term “lithium salt” is hereby intended to denote a substance which needs to be dissolved in a solvent to ensure ionic conduction.

In a lithium secondary battery, a liquid electrolyte consists mainly of lithium salts in a non-aqueous organic solvent where lithium ions (i.e. Li⁺ cations) are used as charge carriers such that the liquid electrolyte acts as a conductive pathway for the movement of cations, i.e. Li⁺ cations passing from the cathode to anode during the discharge. The dissolution of a lithium salt is through solvent-Li⁺ interactions, i.e. the dissociation of Li⁺ cation-(counter)anion interaction is critical. Accordingly, many simple lithium salts are excluded from electrolyte usage because their strong cation-anion interactions result in high lattice energies and thus poor solubility in relevant aprotic solvents, e.g. LiCl, LiF, Li₂O, etc. Non-limitative examples of a lithium salt include, notably, lithium hexafluorophosphate (LiPF₆), lithium perchlorate (LiCIO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), lithium trifluoromethane sulfonate (LiCF₃SO₃), lithium bis(fluorosulfonyl)imide Li(FSO₂)₂N (LiFSI), lithium bis(trifluoromethanesulfonyl)imide Li(SO₂CF₃)₂N (LiTFSI), and mixtures thereof.

The Li⁺ cation conductivity originates from both the total ionic conductivity and the cation transference number. Given that the cation transference number in a non-aqueous organic solvent is low, e.g. usually smaller than 0.5, the ionic conductivity plays a critical role in the battery performance.

In a nutshell, a liquid electrolyte where at least one lithium salt is dissolved in at least one non-aqueous organic solvent plays a pivotal role as one of the major components of a conventional lithium secondary battery.

In this regard, recent advances in battery fields involve using a solid substance as an electrolyte material and a sulfide-based solid ionic conducting inorganic particle is a promising material among others. In such a solid state battery, a solid electrolyte replaces the function/role of the liquid electrolyte. Although a lot of efforts have been made to understand the ionic transport mechanism in a solid electrolyte, the Li⁺ cation diffusion behavior within a solid electrolyte, i.e. between the interface of electrodes and electrolyte (both the electrode/solid electrolyte interface and the active material/solid electrolyte interface within the electrode), however still lacks in-depth understanding.

Like the liquid electrolyte, a solid electrolyte is an ionic conductor which delivers ions between two electrodes. Unlike the liquid electrolyte, however, a solid electrolyte does not require to be dissociated/dissolved into Li⁺ cations in order to render the solid electrolyte conductive. The lithium cation within a lithium argyrodite Li₆PS₅X (X=Cl, Br or I), for instance, takes a role in the Li⁺ cation diffusion mechanism as passage for Li⁺ cations. However, unlike the lithium salts that dissociate into Li⁺ cations and corresponding counteranions in a non-aqueous solvent constituting a liquid electrolyte, it is understood that the lithium positions within Li₆PS₅X form localized cages where multiple jump processes are possible, i.e. doublet jump, intracage jump and intercage jump, by which Li⁺ cation diffusion/transport occurs (Sulfide and oxide inorganic solid electrolytes forA/I-Solid-State Li Batteries: Nanomaterials 2020, 10, 1606; doi:10.3390/nano10081606 by Reddy et. al). That is, unlike liquid electrolytes, only one species in a solid electrolyte is mobile and the structures have partial site occupancies of said mobile species, i.e. Li⁺ cations, corresponding to cooperative conduction mechanism.

Given the above, a lithium salt clearly differs from a sulfide-based solid ionic conducting inorganic particle containing lithium species in its inorganic structure in that a lithium salt needs to be dissolved in a solvent to ensure ionic conduction, while a sulfide-based solid ionic conducting inorganic particle has an intrinsic ionic conductivity above 0.1 mS/cm at room temperature that is due to the diffusion of a sub-lattice of mobile lithium species in its inorganic framework.

In the present invention, the solid composite electrolyte does not contain a lithium salt.

EP3940846 A1 (Solvay SA) discloses a solid composite electrolyte comprising at least one polymer, at least one sulfide-based solid ionic conducting inorganic particle, and at least one lithium salt, which exhibits excellent ionic conductivity.

In this regard, the solid composite electrolyte according to the present invention differs from the solid composite electrolyte of EA'846 A1 in that the solid composite electrolyte of EA'846 A1 comprises at least one sulfide-based solid ionic conducting inorganic particle and a “conductive” polymer, wherein the conductive polymer requires the presence of a lithium salt, whereas the solid composite electrolyte according to the present invention does not requires the presence of a lithium salt. It is also believed that there might exist two conductive pathways for the movement of cations passing from the cathode to the anode during discharge, i.e. one is a solid electrolyte and the other is so-called a (solid) polymer electrolyte. In the latter, the conduction of cations is implemented through the interactions with the substitutional groups of the polymer chains.

The solid composite electrolyte of the present invention is characterized by a high adhesion property towards a current collector, when it is used in manufacturing an electrode of a solid-state battery, for instance a positive electrode.

In the present invention, the nature of the “current collector” depends on whether the electrode thereby provided is either a positive electrode or a negative electrode. Should the electrode of the invention be a positive electrode, the current collector typically comprises, preferably consists of at least one metal selected from the group consisting of Aluminium (Al), Nickel (Ni), Titanium (Ti), and alloys thereof, preferably Al. Should the electrode of the invention be a negative electrode, the current collector typically comprises, preferably consists of at least one metal selected from the group consisting of Lithium (Li), Sodium (Na), Zinc (Zn), Magnesium (Mg), Copper (Cu) and alloys thereof, preferably Cu.

A second object of the present invention is a slurry for manufacturing a solid composite electrolyte comprising a) at least one fluoroelastomer, b) at least one sulfide-based solid ionic conducting inorganic particle that differs from a lithium salt, and c) at least one non-aqueous solvent, wherein the slurry does not contain a lithium salt.

The fluoroelastomer is as defined in the present invention.

There is no specific restriction imposed on the non-aqueous solvent as long as c) the non-aqueous solvent is able to dissolve a) the fluoroelastomer and is compatible with b) the sulfide-based solid ionic conducting inorganic particle, meaning the solvent has no negative impact on the ionic conductivity of the resulting solid composite electrolyte.

In one embodiment, c) the non-aqueous solvent is selected from the group consisting of nitrile-containing solvents, ethers, esters, thiols, thioethers, ketones, and tertiary amines.

In a preferred embodiment, c) the non-aqueous solvent is a nitrile containing solvent with general formula of R—CN, where R represents an alkyl group. Non-limiting examples of nitrile-containing solvents are acetonitrile, butyronitrile, valeronitrile, isobutylnitrile and the like.

In another preferred embodiment, c) the non-aqueous solvent is an ether with general formula of R₁—O—R₂, where R₁ and R₂ represent independently an alkyl group. Included in the ether solvents are cyclic ethers based on 3, 5 or 6-membered rings. The cyclic ethers can be substituted with alkyl groups, can have unsaturation and can have additional functional elements such as nitrogen or oxygen atoms inside the ring. Non-limiting examples of (cyclic) ether solvents are diethylether, 1,2-dimethoxyether, cyclopentyl methyl ether, diethyl ether, dibutyl ether, 1,3-dioxolane, anisole, tetrahydrofuran, methyl tetrahydrofuran, tetrahydropyran and the like.

In another preferred embodiment, c) the non-aqueous solvent is an ester with general formula of R₃—COO—R₄, where R₃ and R₄ represent independently an alkyl group. Non-limiting examples of ester solvents are butyl butyrate, ethyl benzoate and the like.

In another preferred embodiment, c) the non-aqueous solvent is a thiol with general formula of R₅=S—H or thioether with general formula of R₆—S-R₇, where R₅, R₆ and R₇ are independently an alkyl group. Included in the thioether solvents are cyclic thioethers based on 3, 5 or 6 membered rings. The cyclic thioethers can be substituted with alkyl groups, can have unsaturation and can have additional functional elements such as nitrogen or oxygen atoms inside the ring. Non-limiting examples of thiol solvents are ethanethiol, tert-dodecyl mercaptan, thiophenol, tert-butyl mercaptan, octanethiol, dimethylsulfide, ethylmethylsulfide, methyl benzylsulfide and the like.

In another preferred embodiment, c) the non-aqueous solvent is a ketone with general formula of R₈R₉C═O, where R₈ and R₉ represent independently an alkyl group. Non-limiting examples of ketone solvents are methyl ethyl ketone, methyl isobutyl ketone, di-isobutyl ketone, acetophenone, benzophenone and the like, preferably methyl isobutyl ketone.

In another preferred embodiment, c) the non-aqueous solvent is a tertiary amine with general formula of R₁₀R₁₁R₁₂N, where R₁₀, R₁₁ and R₁₂ represent independently an alkyl group. The N atom of the tertiary amine can be buried inside a 3, 5 or 6 membered ring. Non-limiting examples of tertiary amine solvents are triethylamine, dimethylbutylamine, tributylamine, cyclohexyldimethylamine, N-ethylpiperidine and the like.

In the present invention, the alkyl groups of R₁ to R₁₂ respectively refer to “alkyl groups” including saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups as defined above. Additionally, the alkyl groups may include functional groups such as 1 or more unsaturation, ether, carbonyl, carboxyl, hydroxyl, thio, thiol, thioxy, sulfo, nitrile, nitro, nitroso, azo, amide, imide, amino, imino or halogen.

In a preferred embodiment, c) the non-aqueous solvent comprises nitrile-containing solvents, such as acetonitrile; ethers, such as tetrahydrofuran, 2-methyl-tetrahydrofuran, 2,5-dimethyl-tetrahydrofuran, 1,3-dioxolane, diethyl ether and 1,2-dimethoxyether; esters, such as butyl butyrate; and ketones such as methyl isobutyl ketone.

In a more preferred embodiment, c) the non-aqueous solvent is an ester, such as butyl butyrate.

In another more preferred embodiment, c) the non-aqueous solvent is a ketone, such as methyl isobutyl ketone.

In one embodiment, the slurry may further comprise a second solvent, for instance saturated hydrocarbons and aromatic hydrocarbons such as, but not limited to, linear and branched alkanes (e.g. heptane), cyclic alkanes (e.g. cyclohexane), and aromatics (e.g. xylene and toluene).

In the present invention, the slurry can be suitably prepared by a process comprising mixing a) a fluoroelastomer, b) a sulfide-based solid ionic conducting inorganic particle and c) a non-aqueous solvent by any method known to the person skilled in the art. In a preferred embodiment, the slurry is prepared by a process comprising solubilizing a) a fluoroelastomer in c) a non-aqueous solvent, followed by adding b) a sulfide-based solid ionic conducting inorganic particle, and mixing the resulting mixture.

In the present invention, the amount of a) a fluoroelastomer in a slurry is such to provide a solid composite electrolyte including a) the fluoroelastomer in an amount ranging at least 1.0 wt %, preferably at least 1.5 wt %, more preferably 2.0 wt %, and/or at most 20.0 wt %, preferably at most 15.0 wt %, more preferably at most 10.0 wt %, most preferably at most 5.0 wt % with respect to the total weight of a) the fluoroelastomer and b) the sulfide-based solid ionic conducting inorganic particle.

In a particular embodiment, the amount of a) a fluoroelastomer in a slurry is such to provide a solid composite electrolyte including a) the fluoroelastomer in an amount ranging from 1.0 to 20.0 wt %, preferably from 1.5 to 15.0 wt %, more preferably from 2.0 to 10.0 wt %, and most preferably 2.0 to 5.0 wt % with respect to the total weight of a) the fluoroelastomer and b) the sulfide-based solid ionic conducting inorganic particle. Accordingly, the resulting solid composite electrolyte exhibits good cohesion between a) the fluoroelastomer and b) the sulfide-based solid ionic conducting inorganic particles, while maintaining good ionic conductivity.

The slurry according to the present invention is typically applied onto at least one foil of inert flexible support by a technique selected from casting, spray coating, rotating spray coating, roll coating, doctor blading, slot die coating, gravure coating, ink-jet printing, spin coating, and screen printing. In one embodiment, the wet film so obtained typically has a thickness of from 10 to 400 μm, preferably from 50 to 200 μm. The wet film is then dried at a temperature between 10° C. and 200° C., preferably between 20° C. and 80° C. An additional drying step in an oven under vacuum at a temperature between 20° C. and 150° C., preferably between 50° C. and 80° C., can be suitably carried out to completely remove the solvent. The skilled person in the art may select the optimal duration and temperature of the drying step, depending on the boiling point of the solvent. The dry film thusly obtained can be further subject to an additional compression step, such as calendaring, uniaxial or isostatic compression process, to lower the porosity and to increase the density of the solid composite electrolyte.

In another embodiment, the slurry may further comprise d) at least one electroactive material, and optionally e) at least one conductive agent.

In a preferred embodiment, d) the electroactive material is for a positive electrode.

In the present invention, the term “positive electrode” is intended to denote, in particular, the electrode of an electrochemical cell, where reduction occurs during discharging, while the term “negative electrode” is intended to denote, in particular, the electrode of an electrochemical cell, where oxidation occurs during discharging.

In the present invention, the term “electroactive material” is intended to denote a material that is able to incorporate or insert into its structure and substantially release therefrom lithium ions during the charging and discharging phases in a battery.

In the case of forming a positive electrode for a solid-state battery, the electroactive material for a positive electrode is not particularly limited. It may comprise a composite metal chalcogenide of formula LiMQ₂, wherein M is at least one metal selected from transition metals such as Co, Ni, Fe, Mn, Cr, and V and Q is a chalcogen such as O and S. Among these, it is preferred to use a lithium-based composite metal oxide of formula LiMO₂, wherein M is the same as defined above. Preferred examples thereof may include LiCoO₂, LiNiO₂, LiNixCo₁₋ₓO₂ (0≤x≤1), and spinel-structured LiMn₂O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}CO_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂.

As an alternative, still in the case of forming a positive electrode for a lithium metal battery, the electroactive material of a positive electrode may comprise a lithiated or partially lithiated transition metal oxyanion-based electroactive material of formula M₁M₂(JO₄)_{f}E_{1-f}, wherein M₁ is lithium, which may be partially substituted by another alkali metal representing less that 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, Jo₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electroactive material as defined above is preferably phosphate-based and may have an ordered or modified olivine structure.

More preferably, the electroactive material of a positive electrode has formula Li₃₋ₓM′_{y}M″_{2-y}(JO₄)₃ wherein O≤x≤3, O≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electroactive material is a phosphate-based electroactive material of formula Li(FeₓMn₁₋ₓ)PO₄ wherein 0≤x≤1, preferably x=1, i.e. lithium iron phosphate of formula LiFePO₄.

In a preferred embodiment, the electroactive material of a positive electrode is selected from the group consisting of LiMQ₂, wherein M is at least one metal selected from Co, Ni, Fe, Mn, Cr and V and Q is 0 or S; LiNiₓCo₁₋ₓO₂ (0≤x≤1); spinel-structured LiMn₂O₄; lithium-nickel-manganese-cobalt-based metal oxide of formula LiNiₓMn_{y}Co_{z}O₂ (x+y+z=1) (NMC), lithium-nickel-cobalt-aluminum-based metal oxide of formula LiNiₓCo_{y}Al_{z}O₂ (x+y+z=1) (NCA), lithium-cobalt-based metal oxide (LCO), lithium-nickel-manganese-based metal oxide (LNMO) and LiFePO₄.

In a more preferred embodiment, the electroactive material of a positive electrode is selected from the group consisting of NMC, NCA, LCO, and LNMO.

In the present invention, the term “conductive agent” is intended to denote, in particular, a material which is used to ensure electrodes have good charging and discharging performance and to provide additional electrical conductivity. Non-limiting examples of the conductive agent are carbonaceous materials and metal powders or fibers, for instance carbon blacks, carbon nanotubes (CNT), vapor-grown carbon fibers (VGCF), graphite, graphene, graphite fibers and the like. Examples of carbon blacks include Ketjen black and acetylene black. The metal powders or fibers include nickel and aluminium powders or fibers.

In a particular embodiment, the amount of a) a fluoroelastomer in a slurry is such to provide a solid composite electrolyte including a) the fluoroelastomer in an amount ranging from 1.0 to 20.0 wt %, preferably from 1.5 to 15.0 wt %, more preferably from 2.0 to 10.0 wt %, and most preferably 2.0 to 5.0 wt % with respect to the total weight of a) the fluoroelastomer, b) the sulfide-based solid ionic conducting inorganic particle, c) the electroactive material, and optionally e) at least one conductive agent.

Accordingly, the resulting electrode exhibits outstanding adhesion towards a current collector.

A third object of the present invention is an electrode comprising a solid composite electrolyte according to the present invention, d) at least one electroactive material, and optionally e) at least one conductive agent.

In one embodiment, d) the electroactive material is for a positive electrode.

In one embodiment, the positive electrode comprises a solid composite electrolyte according to the present invention, d) at least one electroactive material, and optionally e) at least one conductive agent.

In a particular embodiment, the positive electrode comprises a solid composite electrolyte comprising VDF-CTFE copolymer as a) a fluoroelastomer, Li₆PS₅Cl as b) a sulfide-based solid ionic conducting inorganic particle, LiNi_{0.6}Mn_{0.2}Co_{0.2}O₂ as d) an electroactive material for a positive electrode, and optionally a carbon black as e) a conductive agent.

In a more particular embodiment, VDF-CTFE copolymer as a) the fluoroelastomer comprises recurring units derived from CTFE in an amount from 15.0 to 50.0 mol %, the mol % being relative to the total moles of recurring units.

A fourth object of the present invention is a solid-state battery comprising a positive electrode, a negative electrode, and a membrane that is positioned between the positive electrode and the negative electrode, wherein at least one of the positive electrode, the negative electrode and the membrane comprises a solid composite electrolyte according to the present invention, optionally d) at least one electroactive material and/or e) at least one conductive agent.

In the present invention, the term “membrane” is intended to denote, in particular, an ionically permeable membrane placed between a positive electrode and a negative electrode. Its function is to be permeable to the lithium ions while blocking electrons and assuring the physical separation between the electrodes.

A fifth object of the present invention is a binder solution for a solid-state battery comprising a) at least one fluoroelastomer according to the present invention and c) at least one non-aqueous solvent.

The non-aqueous solvent is as defined in the present invention.

A person skilled in the art may easily select the proper amount of c) the non-aqueous solvent in order to achieve uniform dissolution of a) the fluoroelastomer and suitable evaporation of the same, when the binder solution according to the present invention is used in manufacturing a solid composite electrolyte. This solid composite electrolyte may be used either as a membrane positioned between a positive electrode and a negative electrode or as an electrode for solid-state batteries.

Should the disclosure of any patents, patent applications, and publications which are incorporated herein by reference conflict with the description of the present application to the extent that it may render a term unclear, the present description shall take precedence.

The invention will be now explained in more details with reference to the following examples, whose purpose is merely illustrative and not intended to limit the scope of the invention.

### Examples

### Raw Materials

LPSCl (Li₆PS₅Cl), crystalline sulfide-based solid ionic conducting inorganic particles, commercially available from NEI corporation;
NMC622 (Cellcore® NMC KHX12), commercially available from Umicore;
Conductive carbon black (C-NERGY™ SUPER C₆₅T), commercially available from Imerys;
Butyl butyrate (BB), commercially available from Sigma Aldrich; and
Methyl isobutyl ketone (MIBK), commercially available from Sigma Aldrich Fluoroelastomers
Polymer 1: VDF-CTFE (80/20 in mol %), synthesized within Solvay Specialty Polymers Italy S.p.A
Polymer 2: VDF-CTFE (70/30 in mol %), synthesized within Solvay Specialty Polymers Italy S.p.A
Polymer 3: VDF-CTFE (60/40 in mol %), Voltalef® G150M commercially available from Arkema (T_{g}=−16° C.)
Polymer 4: VDF-CTFE (86/14 in mol %), synthesized within Solvay Specialty Polymers Italy S.p.A
Polymer 5: VDF-HFP (78.5/21.5 mol %), Tecnoflon® N935 commercially available from Solvay Specialty Polymers Italy S.p.A (T_{g}=−19° C.).

### Synthesis of Polymers 1, 2 and 4

### Polymer 1:

In a steel vertical autoclave equipped with baffles and stirrer functioning at 550 rpm, 1.3 L of demineralized waterwas introduced. Then the temperature was brought to reaction temperature of 75° C. and 3.5×10⁵ Pa (absolute) of VDF were introduced. The gaseous mixture of VDF-CTFE in a nominal molar ratio of 80/20 was added by using a compressor, until reaching a pressure of 20.0×10⁵ Pa (absolute).

The composition of the gaseous mixture present in the autoclave head was analyzed with a gas chromatography, before starting the reaction: 83.5 mol % of VDF and 16.5 mol % CTFE. Subsequently, 45.0 cc of ammonium persulfate ((NH₄)₂S₂O₈) solution in ethyl acetate (3% w/w) and 2 ml of pure ethyl acetate was fed into the autoclave.

The polymerization pressure was maintained constant by feeding said monomeric mixture and when 300.0 g of the mixture was fed, the feeding was stopped, the reactor was cooled down to room temperature and then degassed in order to remove the residual, i.e. unreacted monomers. The latex as produced was discharged and further degassed with nitrogen for 24 hours. Then the resulting polymer was isolated by using standard isolation procedure with aluminum sulfate (Al₂(SO₄)₃) and then dried in a vented oven for 24 hours at 90° C.

### Polymer 2:

Polymer 2 was synthesized in the same manner as Polymer 1, except that the gaseous mixture of VDF-CTFE in a nominal molar ratio of 70/30 was added with 3.3×10⁵ Pa (absolute) of VDF. The composition of the gaseous mixture present in the autoclave head was analyzed with a gas chromatography, before the reaction started: 73.8 mol % of VDF and 26.2 mol % CTFE.

### Polymer 4:

Polymer 4 was synthesized in the same manner as Polymer 1, except that the gaseous mixture of VDF-CTFE in a nominal molar ratio of 86/14 was added with 3.8×10⁵ Pa (absolute) of VDF. The composition of the gaseous mixture present in the autoclave head was analyzed with a gas chromatography, before the reaction started: 88.8 mol % of VDF and 11.2 mol % CTFE.

### Preparation of Solid Composite Electrolytes

### Inventive Example 1 (E1)

A solid composite electrolyte composed of 95.0 parts by weight (pbw) of LPSCl and 5.0 pbw of Polymer 1 was produced in the form of a film as the following:

10.0 wt % of a polymer solution was prepared by weighing 1.0 g of Polymer 1 and 9.0 g of BB. Subsequently, 3.705 g of LPSCl, 1.95 g of the 10.0 wt % of the polymer solution and 0.345 g of BB were mixed with 4 glass balls under magnetic stirring at 400 rpm for a minimum of 6 hours. The solid content of the slurry and the casting speed were adapted in order to maintain the slurry viscosity during casting between 2.0 and 10.0 Pa·s. The obtained slurry was cast on a flexible support (Kapton® FN) by using an automatic film applicator from Elcometer Ltd. The wet film was dried at 50° C. on a hot plate for one hour and then placed in an oven at 80° C. under vacuum during the night. The samples were stored in a minigrip bag and then placed in a sealed bag. All experiments were performed in an Argon-filled glove box.

### Inventive Example 2 (E2) and Inventive Example 3 (E3)

The solid composite electrolytes of E2 and E3 were prepared in the same manner as E1, except that Polymer 2 and Polymer 3 were used respectively instead of Polymer 1.

### Inventive Example 4 (E4)

The solid composite electrolyte of E4 was prepared in the same manner as E1, except that MIBK was used as a solvent instead of BB.

### Comparative Example 1 (CE1)

CE1 was prepared in the same manner as E1, except that Polymer 4 was used instead of Polymer 1. With CE1, both BB and MIBK were tried respectively as a solvent. However, Polymer 4 was not soluble either in BB or in MIBK so that a solid composite electrolyte in the form of a film couldn't be formed.

### Comparative Example 2 (CE2)

The solid composite electrolyte of CE2 was prepared in the same manner as E1, except that Polymer 5 was used instead of Polymer 1.

### Comparative Example 3 (CE3)

The solid composite electrolyte of CE3 was prepared in the same manner as CE2, except that MIBK was used as a solvent instead of BB.

### Preparation of Positive Electrode

Positive electrodes of E1-E3 and CE2 composed of 74.0 pbw of NMC622, 20.0 pbw of LPSCl, 2.0 pbw of conductive carbon black, and 4.0 pbw of a fluoroelastomer (selected from Polymers 1 to 3 & Polymer 5, respectively) were produced as the following:

A 10.0 wt % of a binder solution was prepared by weighing 1.0 g of a fluoroelastomer and 9.0 g of BB. Subsequently, 1.0 g of LPSCl, 0.1 g of conductive carbon, 3.7 g of NMC622 and 2.0 g of the 10.0 wt % of the binder solution were mixed with 4 glass balls under magnetic stirring at 400 rpm for a minimum of 6 hours. The slurry as obtained was cast on an aluminium (Al) current collector by using an automatic film applicator from Elcometer Ltd. The solid content of the slurry and the casting speed were adapted in order to maintain the slurry viscosity during casting between 2.0 and 10.0 Pa·s and in order to obtain a dry electrode loading of from 25.0 to 30.0 mg/cm². The wet film was dried at 50° C. on a hot plate for one hour, placed in an oven at 80° C. under vacuum during the night, stored in a minigrip bag, and then placed in a sealed bag. The experiment was performed in an Argon-filled glove box.

Positive electrodes of E4 and CE3 were produced in the same manner as above described, except that MIBK was used as a solvent instead of BB.

### Adhesion of Positive Electrode to Al Current Collector (Peel-Off Test)

The adhesion strength of the positive electrode to the Al current collector was evaluated using a 180° peel test. An electrode strip (2 cm*10 cm) of the dried electrode was fixed with the electrode facing down and the current collector facing up on a rigid Al plate (2.6 cm*10 cm) using a double sided tape (width 25 mm; thickness 0.24 mm). The Al current collector was peeled off from the electrode using a motorized tension/compression force test stand (ESM303 from Mark-10 Corporation), maintaining an angle of 180° and at a constant speed of 300 mm/min. The force needed to remove the Al current collector from the electrode was recorded in Table 1 as an average value of 3 independent strips, generated from 3 independent electrodes using 3 independent slurries with the same composition. Peel-off tests were performed in a dry room with dew point of −40° C.

In all positive electrodes of E1 to E4, outstanding adhesion properties towards the Al current collector were clearly observed, distinguishable from those of CE2 and CE3.

### Bending Test of Solid Composite Electrolytes E1, E3 & CE2

The bending test was implemented to measure the flexibility/elongation properties of a solid composite electrolyte by using a cylindrical mandrel bend tester (Elcometer@1506). The tester has a bending lever with height-adjustable rollers and a sliding vice for clamping the sample so that the test piece is bent perfectly and regularly on decreasing mandrels, until the desired effect can be obseved.

The solid composite electrolytes of E1, E3 and CE2 in the form of free standing films were bent over the different cylinders varying from large to small diameter. The diameter of the first cylinder when a crack started to appear while bending the film over a cylinder was observed. The results were recorded in Table 1. For the solid composite electrolytes of E1 and E3, first cracks were observed when bending over a cylinder with diameter of 2 mm, while the one of CE2 started to crack earlier when they were bent over a cylinder with diameter of 3 mm.

Ionic conductivity of Solid composite electrolytes E1, E3 & CE2

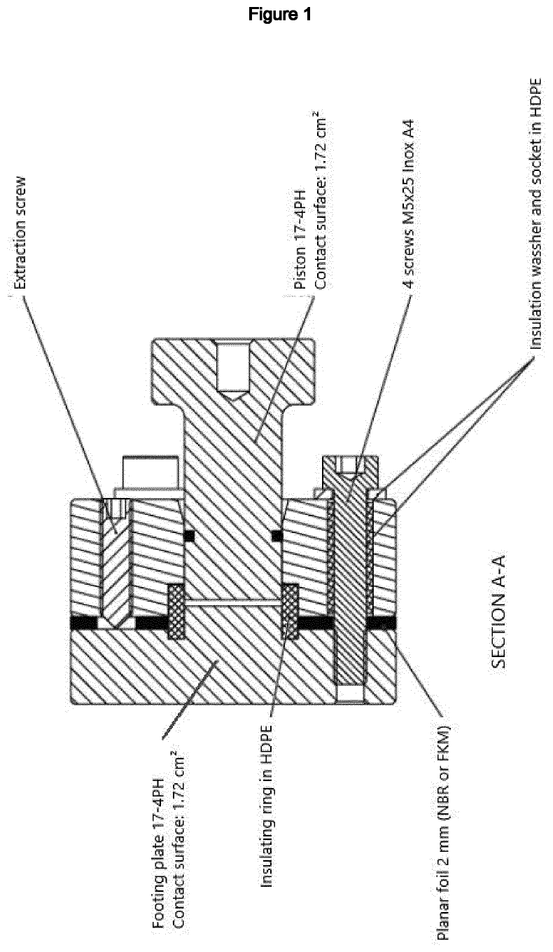

The ionic conductivity of the solid composite electrolytes of E1, E3 and CE2 in the form of films were measured by AC impedance spectroscopy with an in-house developed pressure cell, where the film was pressed between two stainless steel electrodes during impedance measurements. A cross section of the pressure cell is shown in FIG. 1.

The impedance spectra were determined at a pressure of 370 MPa and a temperature of 20° C. The AC impedance measurements were performed with a potentiostate (VMP-300, BioLogic Science Instruments SAS) in the frequency range of 1000 Hz to 4.7 MHz.

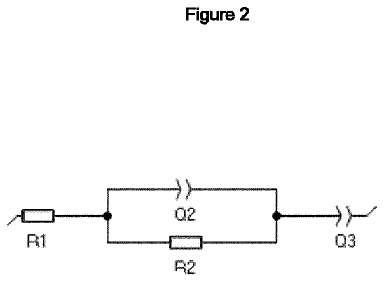

The Nyquist plot of the soild composite electrolytes showed the typical behaviour of a solid electrolyte (inorganic, polymer or composite) with a semicircle and Warburg-type impedance in the high and low frequency region respectively. The conductivity behaviour of the composite electrolyte was modelled according to the equivalent circuit R1(R2/Q2)Q3 (see FIG. 2) in which R is a resistance and Q a constant phase element, wherein R1 and R2 represent the bulk and grain boundary resistance respectively, and Q2 and Q3 the grain boundary and electrode contributions respectively.

The intercept of the semicircle with the real axis at high frequency is attributed to the bulk resistance (R1) and the intercept with the real axis at lower frequency is attributed to the total resistance (R1+R2) of the films. This total resistance, R, is conventionally used to calculate the conductivity of the solid composite electrolyte. Accordingly the ionic conductivity, σ, was obtained using the equation of σ=d/(R×A), wherein d is the thickness of the film and A is the area of the stainless steel electrode. The SI unit of ionic conductivity is Siemens per meter (S/m), wherein S is ohm⁻¹, and 1 milisiemens per centimeter (mS/cm) is a decimal fraction of the SI unit, i.e. 1 mS/cm=0.1 S/m.

TABLE 1

| | | | | Ionic | |
|---|---|---|---|---|---|
| | | | Peel-off | conductivity | Bending |
| | Fluoroelastomer | Solvent | (N/m) | (mS/cm) | test |
| E1 | Polymer 1 | BB | 145 | 0.84 | 2 mm |
| E2 | Polymer 2 | BB | 157 | — | — |
| E3 | Polymer 3 | BB | 139 | 0.91 | 2 mm |
| E4 | Polymer 1 | MIBK | 142 | — | — |
| CE1 | Polymer 4 | BB/MIBK | NA* | — | — |
| CE2 | Polymer 5 | BB | 58 | 0.87 | 3 mm |
| CE3 | Polymer 5 | MIBK | 45 | — | — |

*NA: not available

1. A solid composite electrolyte comprising:
a) at least one fluoroelastomer; and
b) at least one sulfide-based solid ionic conducting inorganic particle that differs from a lithium salt;
wherein a) the at least one fluoroelastomer comprises recurring units derived from
i) vinylidene difluorides (VDF); and
ii) from 15.0 to 80.0% by mol (mol %) of at least one C₂-C₈ chloro and/or bromo and/or iodo fluoroolefin, the mol % being relative to the total moles of recurring units,
wherein the solid composite electrolyte does not contain a lithium salt.

2. The solid composite electrolyte according to claim 1, wherein ii) the C₂-C₈ chloro and/or bromo and/or iodo fluoroolefin accounts for from 15.0 to 65.0 mol %, the mol % being relative to the total moles of recurring units.

3. The solid composite electrolyte according to claim 1, wherein ii) the C₂-C₈ chloro and/or bromo and/or iodo fluoroolefins is selected from the group consisting of 1,1-chlorofluoroethylene (CFE), chlorodifluoroethylene (CDFE), bromotrifluoroethylene, chlorotrifluoroethylene (CTFE), 1,2-dichloro-1,2-difluoroethylene, iodotrifluoroethylene, and combinations thereof.

4. The solid composite electrolyte according to claim 1, wherein a) the at least one fluoroelastomer further comprises recurring units derived from iii) at least one C₂-C₈ fluoroolefin, different from i) and ii).

5. The solid composite electrolyte according to claim 4, wherein iii) the C₂-C₈ fluoroolefin is selected from the group consisting of vinyl fluoride (VF), trifluoroethylene (TrFE), tetrafluoroethylene (TFE), hexafluoropropylene (HFP), hexafluoroisobutylene, and combinations thereof.

6. The solid composite electrolyte according to, wherein a) the at least one fluoroelastomer has a heat of fusion, as measured according to ASTM D3418, of less than 5.0 J/g.

7. The solid composite electrolyte according to claim 1, wherein b) the sulfide-based solid ionic conducting inorganic particle is selected from the group consisting of:
lithium tin phosphorus sulfide (“LSPS”) materials of formula Li₁₀SnP₂Si₂;
lithium phosphorus sulfide (“LPS”) materials, of formula (Li₂S)ₓ—(P₂S₅)_{y}, wherein x+y=1 and 0≤x≤1, Li₇P₃S₁₁, Li₇PS₆, Li₄P₂S₆, Li_{9.6}P₃S₁₂ and Li₃PS₄;
doped LPS, of formula Li₂CuPS₄, Li Li₁₊₂ₓZn₁₋ₓPS₄, wherein 0≤x≤1, Li_{3.33}Mg_{0.33}P₂S₆, and Li₄₋₃ₓSCₓP₂S₆, wherein 0≤x≤1;
lithium phosphorus sulfide oxygen (“LPSO”) materials of formula LiₓP_{y}S_{z}O, where 0.33≤x≤0.67, 0.07≤y≤0.2, 0.4≤z≤0.55, 0≤w≤0.15;
lithium phosphorus sulfide materials including X (“LXPS”), wherein X is Si, Ge, Sn, As, Al, such as Li₁₀GeP₂S₁₂ and Li₁₀SiP₂S₁₂;
lithium phosphorus sulfide oxygen including X (“LXPSO”), wherein X is Si, Ge, Sn, As, Al;
lithium silicon sulfide (“LSS”) materials;
lithium boron sulfide materials of formula Li₃BS₃ and Li₂S— B₂S₃—LiI;
lithium tin sulfide materials and lithium arsenide materials of formula Li_{0.8}Sn_{0.8}S₂, Li₄SnS₄, Li_{3.833}Sn_{0.833}As_{0.166}S₄, Li₃AsS₄—Li₄SnS₄, Ge-substituted Li₃AsS₄; and
lithium phosphorus sulfide materials of general formula LiₐPS_{b}X_{c}, wherein X represents at least one halogen element selected in the group of Cl, Br and I or a combination thereof; and a represents a number from 2.0 to 7.0, b represents a number from 3.5 to 6.0, and c represents a number from 0 to 3.0.

8. A slurry for manufacturing a solid composite electrolyte according to claim 1, comprising a) the at least one fluoroelastomer, b) the at least one sulfide-based solid ionic conducting inorganic particle that differs from a lithium salt, and c) at least one non-aqueous solvent, wherein the slurry does not contain a lithium salt.

9. The slurry according to claim 8, wherein c) the at least one non-aqueous solvent is selected from the group consisting of nitrile-containing solvents, ethers, esters, thiols, thioethers, ketones, tertiary amines, and cyclic carbonate esters, preferably butyl butyrate and/or methyl isobutyl ketone.

10. The slurry according to claim 8, further comprising d) at least one electroactive material and optionally e) at least one conductive agent.

11. The slurry according to claim 10, wherein d) the electroactive material is for a positive electrode and is selected from the group consisting of lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), lithium-cobalt-based metal oxide, and lithium-nickel-manganese-based metal oxide.

12. An electrode comprising the solid composite electrolyte according to claim 1, d) at least one electroactive material, and optionally e) at least one conductive agent.

13. The electrode according to claim 12, wherein d) the electroactive materials is for a positive electrode, and is selected from the group consisting of lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), lithium-cobalt-based metal oxide, and lithium-nickel-manganese-based metal oxide.

14. A solid-state battery comprising a positive electrode, a negative electrode, and a membrane that is positioned between the positive electrode and the negative electrode, wherein at least one of the positive electrode, the negative electrode, and the membrane, comprises the solid composite electrolyte according to claim 1, optionally further comprising d) at least one electroactive material and/or e) at least one conductive agent.

15. A binder solution for a solid-state battery comprising a) at least one fluoroelastomer and c) at least one non-aqueous solvent, wherein a) the at least one fluoroelastomer comprises recurring units derived from:
i) vinylidene difluorides (VDF); and
ii) from 15.0 to 80.0 mol % of at least one C₂-C₈ chloro and/or bromo and/or iodo fluoroolefin, the mol % being relative to the total moles of recurring units.
